(19) United States
(12) Patent Application Publication
(10) Pub. No.: US 2025/0203586 A1
(43) Pub. Date: Jun. 19, 2025

(54) TERMINAL APPARATUS THAT TRANSMITS COMMUNICATION SIGNALS

(71) Applicant: JVCKENWOOD Corporation, Yokohama-shi (JP)

(72) Inventor: Katsuhiko NAKAZAWA, Yokohama-shi (JP)

(21) Appl. No.: 19/066,226

(22) Filed: Feb. 28, 2025

Related U.S. Application Data
(63) Continuation of application No. PCT/JP2023/029926, filed on Aug. 21, 2023.

(30) Foreign Application Priority Data
Sep. 9, 2022 (JP) 2022-143920

(51) Int. Cl. H04W 72/0446; H04W 64/00; H04W 92/18

(52) U.S. Cl. CPC H04W 72/0446; H04W 64/00; H04W 92/18

(57) ABSTRACT

A terminal apparatus includes a communication interface, a controller, and a storage. The communication interface executes time-division wireless communication with other terminal apparatuses. A storage stores a communication signal transmitted from the communication interface or a communication signal received by the communication interface. A controller controls transmission in the communication interface. The controller calculates a transmission time based on information included in the communication signal. The communication interface transmits the communication signal stored in the storage at the transmission time calculated by the controller.

### CROSS-REFERENCE TO RELATED APPLICATION

This application is based upon and claims the benefit of priority from the prior Japanese Patent Application No. 2022-143920, filed on Sep. 9, 2022, the entire contents of which is incorporated herein by reference.

### BACKGROUND

### 1. Technical Field

The present disclosure relates to communication technology and, in particular, to terminal apparatuses that transmit communication signals.

### 2. Description of the Related Art

In a multi-hop wireless network, each wireless station performs a relay to transmit information. This enables communication between wireless stations that cannot communicate directly with each other by relaying signals in one or more wireless stations located between them (e.g., Patent Literature 1).
[Patent Literature 1] JP2001-237764

In affected areas, functions of wireless base stations, communication networks, or the like may be damaged and cannot be used. In such a situation, it is required to transmit information to all wireless stations in a specific area. In this process, information needs to be disseminated quickly. In a conventional multi-hop wireless network, however, a relay route is determined for communication to a specific wireless station, and information is not transmitted to all wireless stations located in a specific area.

### SUMMARY

A terminal apparatus according to an embodiment of the present disclosure includes: a communication interface that executes time-division wireless communication with other terminal apparatuses; a storage that stores a communication signal transmitted from the communication interface or a communication signal received by the communication interface; and a controller that controls transmission in the communication interface. The controller calculates a transmission time based on information included in the communication signal, and the communication interface transmits the communication signal stored in the storage at the transmission time calculated by the controller.

Optional combinations of the aforementioned constituting elements, and implementations of the disclosure in the form of methods, apparatuses, systems, recording mediums, and computer programs may also be practiced as additional modes of the present disclosure.

According to the present disclosure, messages can be efficiently delivered to a specific area.

### BRIEF DESCRIPTION OF THE DRAWINGS

FIG. 1 shows a configuration of a wireless communication system according to the embodiment.

FIG. 2 shows a configuration of the terminal apparatus of FIG. 1.

FIG. 3 shows a format of the communication signal received or transmitted by the communication interface of FIG. 2.

FIG. 4 shows a data structure of a message table stored in the storage of FIG. 2.

FIG. 5 shows a data structure of a timetable stored in the storage of FIG. 2.

FIG. 6 is a flowchart showing a sequence of steps for transmission by the terminal apparatus of FIG. 2.

FIG. 7 is a flowchart showing a sequence of steps for reception performed by the terminal apparatus of FIG. 2.

FIG. 8 is a flowchart showing a sequence of steps for transfer by the terminal apparatus of FIG. 2.

### DETAILED DESCRIPTION

The invention will now be described by reference to the preferred embodiments. This does not intend to limit the scope of the present invention, but to exemplify the invention.

A summary will be given before describing the embodiment in specific details. The embodiment relates to a wireless communication system in which communication signals are transferred by a plurality of terminal apparatuses. As described above, it is required to distribute messages efficiently to a specific area in such a wireless communication system. The embodiment addresses this by, for example, providing a multi-hop wireless network that distributes messages only to a specific area efficiently in a terminal apparatus for disaster countermeasures. Specifically, the embodiment provides a simulcast scheme for establishing synchronization between a plurality of terminal apparatuses for transmission and a designation method for distributing messages only within a required area.

The terminal apparatus has a wireless relay function and, when it receives a communication signal to be transferred, stores the signal in a storage. A plurality of terminal apparatuses that have stored the same communication signal in the storage synchronously transmit the stored communication signal by simulcast at a specific point of time. Another plurality of terminal apparatuses that receive the communication signal transmitted synchronously transmit the stored communication signal synchronously at the next specific point of time. Subsequently, a plurality of terminal apparatuses synchronously and sequentially transfer the communication signal. Thereby, the communication signal is disseminated.

The communication signal transferred in this process includes range information indicating an area to which the communication signal should be transferred. The terminal apparatus acquires position information on the terminal apparatus and transmits the received communication signal at a specific point of time when the position information is within the range information included in the received communication signal and when the upper limit of the valid time is not reached. Hereinafter, the embodiment will be described in the order of (1) overview of the wireless communication system, (2) configuration of the terminal apparatus, (3) operation of the terminal apparatus at the transmission source, (4) transfer in the terminal apparatus, and (5) retransmission in the terminal apparatus.

### (1) Outline of the Wireless Communication System

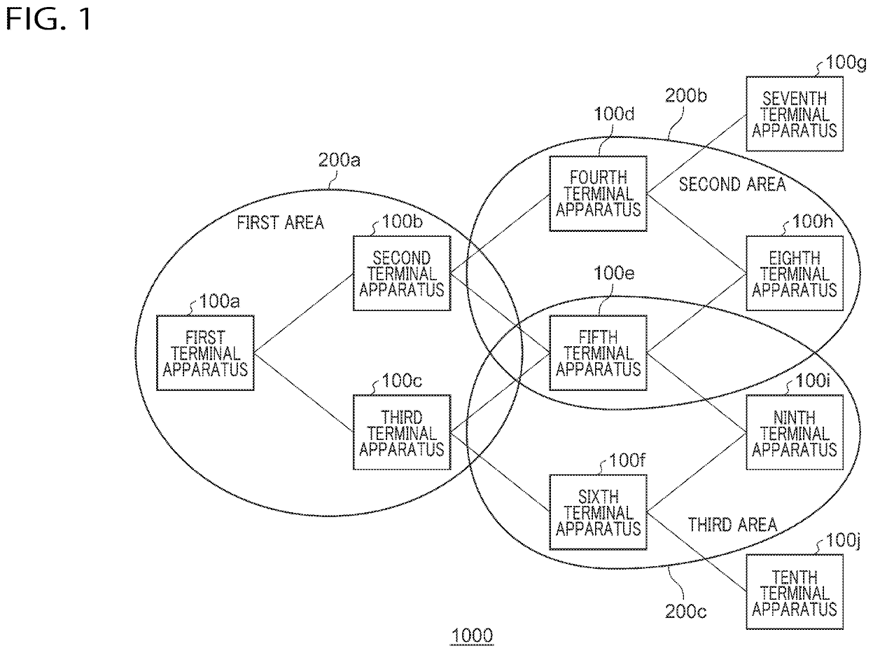

FIG. 1 shows a configuration of a wireless communication system 1000.

The wireless communication system 1000 includes a first terminal apparatus 100a through a tenth terminal apparatus 100j. The number of terminal apparatuses 100 included in the wireless communication system 1000 is not limited to “10”. Each terminal apparatus 100 has a wireless communication function for communication with other terminal apparatuses 100 and has a GNSS (Global Navigation Satellite Systems) positioning function. In this example, the first terminal apparatus 100a is the transmission source of the communication signal by way of one example, and the communication signal transmitted from the first terminal apparatus 100a is sequentially transferred by other terminal apparatuses 100. In this process, each terminal apparatus 100 uses simulcast.

Each terminal apparatus 100 that receives the communication signal accumulates the communication signal and calculates a transmission time based on the message included in the communication signal. Since the message is common, the transmission time calculated in each terminal apparatus 100 is the same. Further, the terminal apparatus 100 transmits the communication signal at the transmission time based on the accurate time obtained by GNSS. As a result, the same communication signal is transmitted simultaneously in the plurality of terminal apparatuses 100. Other terminal apparatuses 100 receive the communication signal. By repeating such a process, a message that warns of a disaster is equally delivered to a further terminal apparatus 100 far away from the first terminal apparatus 100a (disaster warning originator) that made the first transmission and to a still further terminal apparatus 100 that was turned off at the time of first transmission of the communication signal and later turned on.

By transferring the communication signal, the transmission range of the communication signal can be expanded infinitely. To prevent this, the communication signal includes range information. In the case of disaster prevention radio, the geographical range of a municipality is set in the range information. The range information includes the position information on the center and the distance from the center position. Further, a plurality of range information items can be set in one communication signal. The terminal apparatus 100 that receives the communication signal compares its position information with the range information, determines whether its position information is included in the range information, and transmits the communication signal when it is included.

In FIG. 1, the ranges indicated by the range information are shown as a first area 200a through a third area 200c. The first area 200a through the third area 200c are collectively referred to as an area 200. The number of areas 200 set in the wireless communication system 1000 is not limited to “3”. By executing the above-described process, the communication signal transmitted from the first terminal apparatus 100a is transferred to the second terminal apparatus 100b through the tenth terminal apparatus 100j. The seventh terminal apparatus 100g and the tenth terminal apparatus 100j are located outside the area 200 and so discard the received communication signal and do not transfer the received signal.

### (2) Configuration of Terminal Apparatus

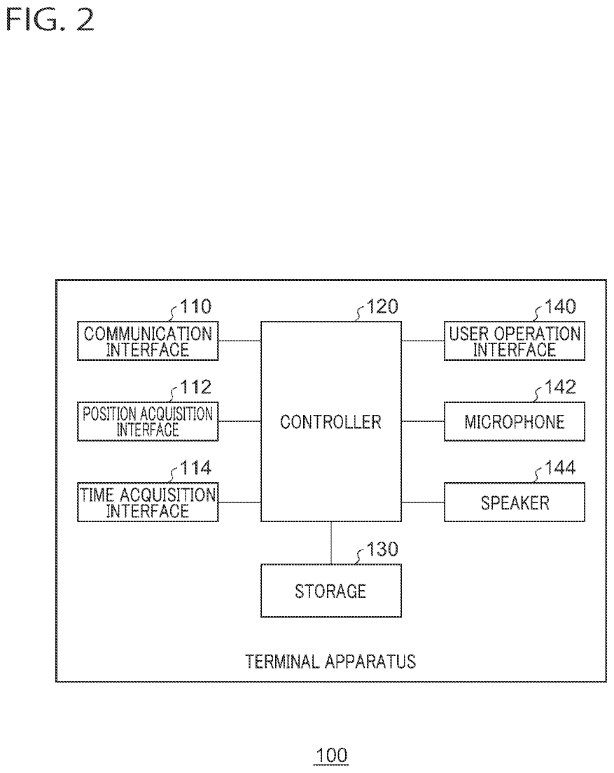

FIG. 2 shows a configuration of the terminal apparatus 100. The terminal apparatus 100 includes a communication interface 110, a position acquisition interface 112, a time acquisition interface 114, a controller 120, a storage 130, an user operation interface 140, a microphone 142, and a speaker 144.

The communication interface 110 executes wireless communication with other terminal apparatuses 100. In particular, the communication interface 110 executes time-division wireless communication in synchronization with other terminal apparatuses 100. The position acquisition interface 112 executes the GNSS positioning function and acquires position information on the terminal apparatus 100. The position information includes, for example, latitude and longitude. The time acquisition interface 114 acquires information on the current time using the GNSS positioning function. This current time information can be said to be the current time common among the terminal apparatuses 100.

The controller 120 controls the operation of the terminal apparatus 100. In particular, the controller 120 controls transmission in the communication interface 110. The storage 130 stores the communication signal transmitted from the communication interface 110 or the communication signal received by the communication interface 110.

The user operation interface 140 is an interface operated by a user using the terminal apparatus 100, and is, for example, a button or a switch. The user operation interface 140 outputs the received user operation to the controller 120. In the case the terminal apparatus 100 executes sound communication by PTT (Push to Talk), the user operation interface 140 is a PTT button. In PTT, the communication interface 110 can transmit a communication signal while the PTT button is being pressed down. Meanwhile, the communication interface 110 can receive a communication signal while the PTT button is not being pressed down. Further, the communication interface 110 can transfer a communication signal in the embodiment while the PTT button is not being pressed down.

The microphone 142 acquires the sound originated by the user when the user is keeping the PTT button pressed down. The microphone 142 converts the acquired sound into an electrical signal and outputs the converted sound (hereinafter referred to as “sound signal”) to the controller 120. When the user does not press down the PTT button, the speaker 144 receives the sound signal from the controller 120, converts the sound signal into a sound, and then outputs the sound. This sound signal is a sound signal included in the communication signal received by the communication interface 110 from another terminal apparatus 100.

### (3) Operation of the Terminal Apparatus at the Transmission Source

As described above, the terminal apparatus 100 at the transmission source corresponds to the first terminal apparatus 100a of FIG. 1. When the user operation interface 140 accepts the user's action of pressing down the button, the user operation interface 140 notifies the controller 120 of the execution of the transmission process. When the controller 120 receives a notification from the user operation interface 140, the controller 120 receives the sound signal from the microphone 142. The controller 120 generates a digital sound signal (hereinafter also referred to as a “sound signal”) by converting the analog sound signal into a digital signal.

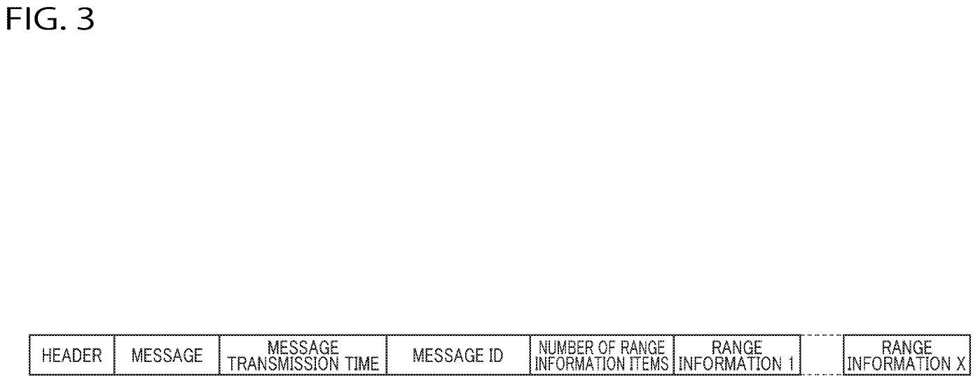

The controller 120 generates a communication signal in which the sound signal is included as a message. FIG. 3 shows a format of the communication signal received or transmitted by the communication interface 110. The communication signal includes a header, a message, a message transmission time, a message ID, the number of range information items, range information 1, . . . , and range information X. The header includes control information in the communication signal. The message is the aforementioned sound signal. The message is not limited to a sound signal and may be character information including a text. The message transmission time indicates the time when the terminal apparatus 100 at the transmission source (e.g., the first terminal apparatus 100a) transmits the communication signal. The time is represented by the time acquired by the time acquisition interface 114.

The message ID is identification information for identifying the message and is randomly generated in the controller 120. “Range information 1” . . . “range information X” indicate the position of the terminal apparatus 100 permitted to transmit the communication signal. For example, “range information 1” indicates the first area 200a of FIG. 1, and “range information 2” indicates the second area 200b of FIG. 1. As described above, each range information includes the position information on the center of the area 200 and the distance from the center position. A plurality of range information items can be set, and the number of range information items is indicated in “the number of range information items”. Reference is made back to FIG. 2. The communication interface 110 transmits the communication signal generated by the controller 120. Further, the controller 120 stores the communication signal transmitted from the communication interface 110 in the storage 130.

### (4) Transfer in the Terminal Apparatus

The communication interface 110 of the terminal apparatus 100 receives the communication signal and outputs the communication signal to the controller 120. The position acquisition interface 112 acquires the position information and outputs the position information to the controller 120. The controller 120 receives the communication signal from the communication interface 110 and receives the position information from the position acquisition interface 112. The controller 120 extracts one or more range information items from the communication signal and determines whether the position information acquired by the position acquisition interface 112 is within the range of any of the range information items. When the position information is not within the range of the range information, the controller 120 terminates the process for the communication signal. This corresponds to the process in the seventh terminal apparatus 100g and the tenth terminal apparatus 100j of FIG. 1. When the position information is within the range of the range information, the controller 120 executes the following processing. This corresponds to the process in the second terminal apparatus 100b through the sixth terminal apparatus 100f, the eighth terminal apparatus 100h through the ninth terminal apparatus 100i of FIG. 1.

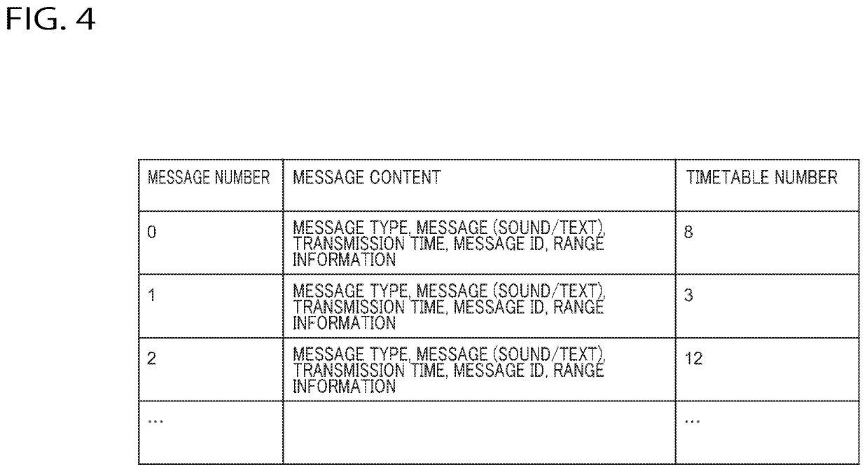

The controller 120 stores the content of the received communication signal in the message table of the storage 130. FIG. 4 shows a data structure of a message table stored in the storage 130. “Message number” is information for identifying a communication signal. For example, message numbers “0”, “1”, “2”, . . . are assigned. “Message content” stores the message type, message, transmission time, message ID, and range information included in the communication signal. “Timetable number” is information on the transmission time calculated by the controller 120 and is stored in association with the message, etc. included in the communication signal. A message table like this is also generated by the first terminal apparatus 100a at the transmission source for the communication signal transmitted. Reference is made back to FIG. 2.

A description will be given of a process for calculating a timetable number in the controller 120. The controller 120 turns the content of the message stored in the storage 130 into a numerical value using a hash function, etc. The controller 120 calculates a timetable number by dividing the numerical value by a prime number. The prime number is set in common in each of the plurality of terminal apparatuses 100 included in the wireless communication system 1000. Prime numbers are used because they have been proven to be arithmetic optimal solutions to avoid the same timetable number across different messages. The maximum value of the common prime that is set for the entire wireless communication system 1000 is a value that can avoid collisions between messages as much as possible according to the frequency of transmission of the message and the period of maintenance of the message. In the terminal apparatuses 100 that receive the same communication signal, the message is the same so that and the timetable number is also the same.

When the calculated timetable number is already included in the message table, the controller 120 adds “1” to the calculated timetable number. That is, “1” is added to the timetable number for the message with the later message transmission time included in the communication signal. When the message table already contains a timetable number derived from adding “1”, the controller 120 further adds “1” to the timetable number. Such additions continue until the timetable number is no longer included in the message table.

The controller 120 sets an expiry time until which the transmission of the communication signal is permitted. For example, the controller 120 sets the time later than the message transmission time by a certain period of time as the expiry time. The controller 120 deletes a message for which the expiry time has elapsed from the message table. Further, the message derived from adding “1” to the timetable number responsive to a duplication of the timetable number is returned to the original timetable number when the message with the original timetable number is deleted.

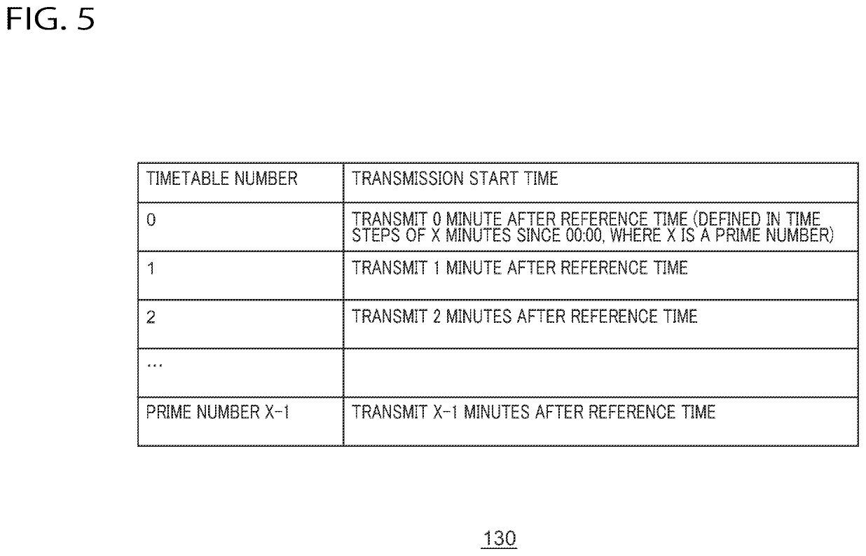

FIG. 5 shows a data structure of a timetable stored in the storage 130. In the timetable, the timetable number and the transmission start time of the communication signal are mapped to each other in one-to-one correspondence. Specifically, the common prime value set in the entire wireless communication system 1000 is used on the vertical axis, and a transmission start time corresponding to each prime value is indicated. The reference time that determines the transmission start time is repeatedly set, staggering the time from each other. The controller 120 acquires the transmission start time corresponding to the timetable number by referring to the timetable. Causing such a process to be performed in each of the plurality of terminal apparatuses 100 ensures the same the transmission start time for the same message in each of the plurality of terminal apparatuses 100.

When the current time acquired by the time acquisition interface 114 is a time before the expiration time, the communication interface 110 transmits the communication signal stored in the storage 130 at the transmission start time acquired by the controller 120. As a result, the same communication signal is transmitted at the same transmission start time from the plurality of terminal apparatuses 100.

### (5) Retransmission in the Terminal Apparatus

The process performed after the terminal apparatus 100 transmits the communication signal in “(3) operation of the terminal apparatus at the transmission source”, “(4) transfer in the terminal apparatus” described above will now be described. Even after a communication signal including a message is transmitted, the message for which the expiry time has not elapsed is retained without being deleted from the message table. For such a message, too, the controller 120 acquires a new transmission start time by executing the aforementioned process. The communication interface 110 transmits the communication signal stored in the storage 130 at the new transmission start time acquired by the controller 120. As a result, the same communication signal is retransmitted at the same transmission start time from the plurality of terminal apparatuses 100.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

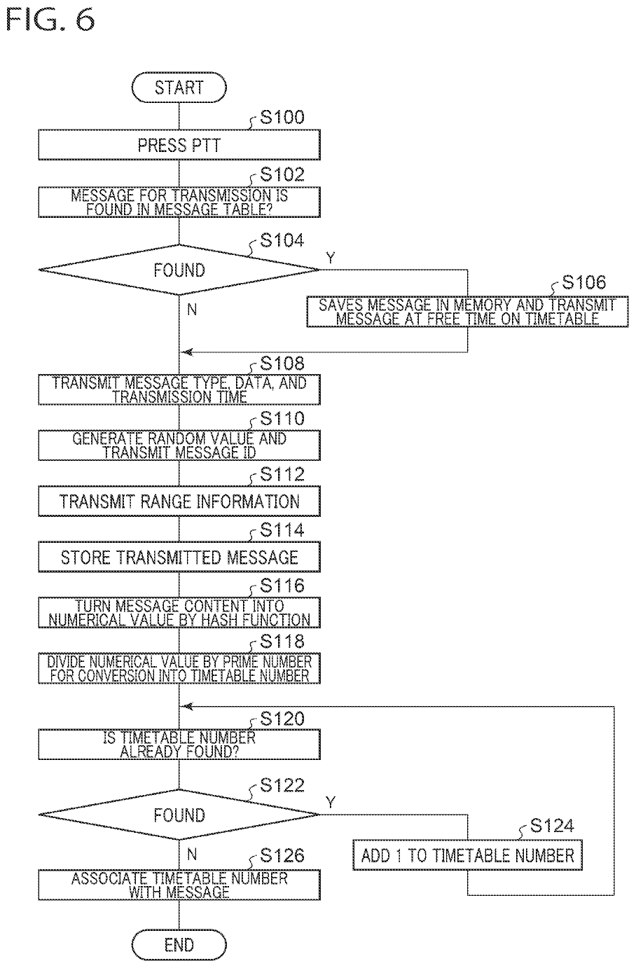

The operation of the wireless communication system 1000 according to the above configuration will be described. FIG. 6 is a flowchart showing a sequence of steps for transmission performed by the terminal apparatus 100. The user operation interface 140 accepts an action of pressing down PTT (S100). The controller 120 checks whether a message is located in the message table stored in the storage 130 (S102). When a message is found (Y in S104), the controller 120 saves the message received as the PTT is pressed in the memory and determines to transmit the message at a point of time available according to the timetable (S106). In the absence of a message (N in S104), step 106 is skipped.

The communication interface 110 transmits the message type, data, and message transmission time (S108), generates a random value generated by the controller 120, transmits the random value as a message ID (S110), and transmits range information (S112). The controller 120 stores the transmitted message in the message table of the storage 130 (S114). The controller 120 turns the message content into a numerical value using a hash function (S116), divides the numerical value by a prime number for conversion into a timetable number (S118). The controller 120 checks whether the generated timetable number is already found in the timetable (S120). When the timetable number is found (Y in S122), the controller 120 adds “1” to the timetable number (S124) and returns to step 120. When the timetable number is not found (N in S122), the controller 120 associates the message with the timetable number (S126).

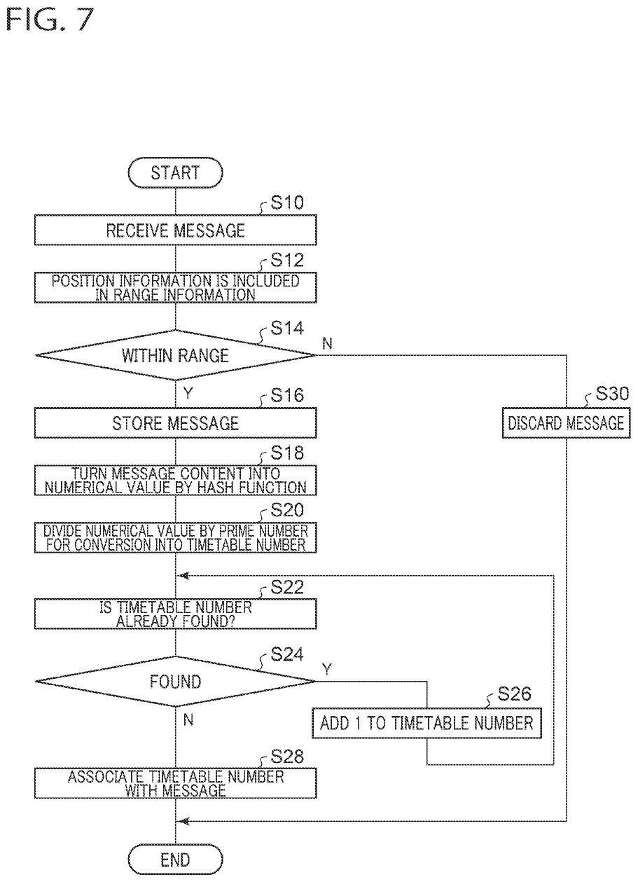

FIG. 7 is a flowchart showing a sequence of steps for reception by the terminal apparatus 100. The communication interface 110 receives a message (S10). The controller 120 checks whether the position information acquired by the position acquisition interface 112 is included in the range information (S12). When the position is within the range (Y in S14), the controller 120 stores the message in the message table of the storage 130 (S16). The controller 120 turns the message content into a numerical value using a hash function (S18), divides the numerical value by a prime number for conversion into a timetable number (S20). The controller 120 checks whether the generated timetable number is already found in the timetable (S22). When the timetable number is found (Y in S24), the controller 120 adds “1” to the timetable number (S26) and returns to step 22. When the timetable number is not found (N in S24), the controller 120 associates the message with the timetable number (S28). When the position is not within the range (N in S14), the controller 120 discards the message (S30) and terminates the process.

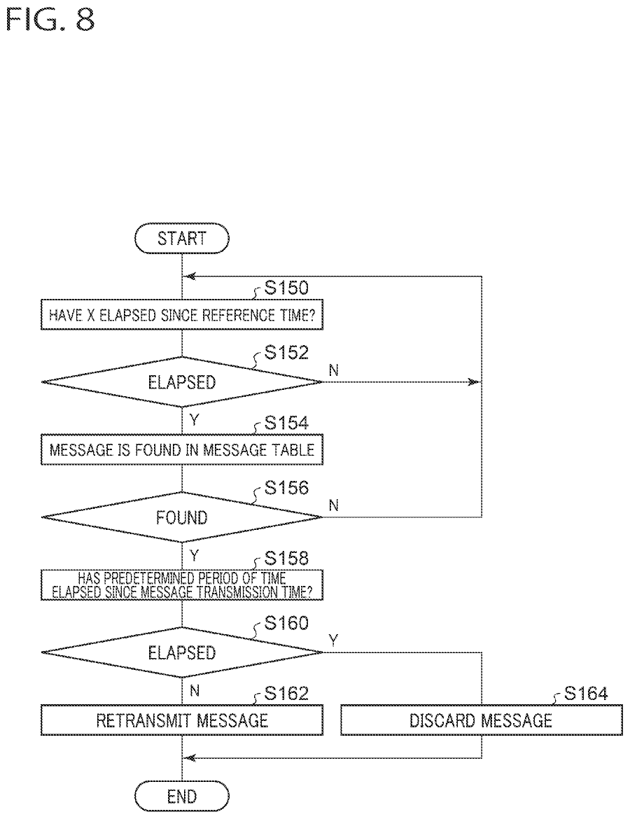

FIG. 8 is a flowchart showing a sequence of steps for transfer by the terminal apparatus 100. The controller 120 checks whether X minutes have elapsed since the reference time (S150). When the time has elapsed (Y in S152), the controller 120 checks whether a message is found in the message table (S154). When a message is found (Y in S156), the controller 120 checks whether a predetermined period of time has elapsed since the message transmission time (S158). When the time has not elapsed (N in S160), the communication interface 110 retransmits the message (S162). When the time has elapsed (Y of S160), the controller 120 discards the message (S164). When X minutes have not elapsed since the reference time (N in S152) or when a message is not found in the message table (N in S156), the controller 120 returns to step 150.

According to the embodiment, the transmission time is calculated based on the content of the message in the received communication signal, and the communication signal is transmitted at the transmission time so that the same communication signal can be transmitted at the same transmission time in a plurality of terminal apparatuses. Further, since the same communication signal is transmitted at the same transmission time in the plurality of terminal apparatuses, the impact from interference in the terminal apparatus that receives the communication signal can be reduced. Further, since the impact from interference in the terminal apparatus that receives the communication signal is reduced, the terminal apparatus can receive the communication signal. Further, since the terminal apparatus receives the communication signal, the communication signal can be transferred.

Further, the timetable number for transmission time is calculated by turning the content of the message in the communication signal into a numerical value and then dividing the numerical value by a prime number, the transmission time common to a plurality of terminal apparatuses can be calculated. Further, the communication signal is transmitted at the transmission time when the position information on the terminal apparatus acquired by the local position acquisition interface is within the range of the range information so that the range in which the communication signal is transferred can be limited.

The present disclosure has been described above based on an exemplary embodiment. In the embodiment, a sound signal has been described, but the embodiment is not limited thereto and is applicable to an information signal such as a data signal. The embodiment is intended to be illustrative only and it will be understood by those skilled in the art that various modifications to constituting elements and processes could be developed and that such modifications are also within the scope of the present disclosure.

What is claimed is:

1. A terminal apparatus comprising:
a communication interface that executes time-division wireless communication with other terminal apparatuses;
a storage that stores a communication signal transmitted from the communication interface or a communication signal received by the communication interface; and
a controller that controls transmission in the communication interface,
wherein the controller calculates a transmission time by turning information in the communication signal into a numerical value and dividing the numerical value by a primer number, and
wherein the communication interface transmits the communication signal stored in the storage at the transmission time calculated by the controller.

2. The terminal apparatus according to claim 1, further comprising:
a position acquisition interface that acquires position information on the terminal apparatus; and
a time acquisition interface that acquires a current time common to terminal apparatuses,
wherein the communication signal includes range information that defines a position of the terminal apparatus permitted to transmit the communication signal,
wherein the storage stores the transmission time calculated by the controller in association with the communication signal, and
wherein the communication interface transmits the communication signal at the transmission time calculated by the controller, when the current time acquired by the time acquisition interface is a time before an expiration time until which transmission of the communication signal is permitted and when the position information on the terminal apparatus acquired by the position acquisition interface is within a range of the range information.

3. The terminal apparatus comprising:
a communication interface that executes time-division wireless communication with other terminal apparatuses;
a storage that stores a communication signal transmitted from the communication interface or a communication signal received by the communication interface; and
a position acquisition interface that acquires position information on the terminal apparatus;
a time acquisition interface that acquires a current time common to terminal apparatuses; and
a controller that controls transmission in the communication interface,
wherein the controller calculates a transmission time based on information included in the communication signal,
wherein the storage stores the transmission time calculated by the controller in association with the communication signal,
wherein the communication signal includes range information that defines a position of the terminal apparatus permitted to transmit the communication signal, and
wherein the communication interface transmits the communication signal at the transmission time calculated by the controller, when the current time acquired by the time acquisition interface is a time before an expiration time until which transmission of the communication signal is permitted and when the position information on the terminal apparatus acquired by the position acquisition interface is within a range of the range information.

4. The terminal apparatus according to claim 3,
wherein the controller calculates the transmission time by turning information in the communication signal into a numerical value and dividing the numerical value by a primer number.
